(19) United States
(12) Patent Application Publication
(10) Pub. No.: US 2026/0155729 A1
(43) Pub. Date: Jun. 4, 2026

(54) ELECTRIC TOOL POWER CONTROL APPARATUS

(71) Applicant: BASSO INDUSTRY CORP., Taichung City (TW)

(72) Inventor: Min-Hsu TSAI, Taichung City (TW)

(73) Assignee: BASSO INDUSTRY CORP., Taichung City (TW)

(21) Appl. No.: 19/337,061

(22) Filed: Sep. 23, 2025

(30) Foreign Application Priority Data
Dec. 2, 2024 (TW) 113213192

(51) Int. Cl. H02M 1/00; B25F 5/02

(52) U.S. Cl. CPC H02M 1/0032; B25F 5/02

(57) ABSTRACT

An electric tool power control apparatus includes a microcontroller, a power converter, a voltage detector, a trigger switch, a first transistor, a second transistor, a third transistor, and a diode. When the trigger switch is turned on, the voltage detector detects a battery voltage, and the voltage detector performs a delay time and keep the third transistor turned off within the delay time, and the power converter receives the battery voltage and converts the battery voltage into a driving voltage and transmits the driving voltage to the microcontroller to drive and wake up the microcontroller, and after the microcontroller is awakened, the microcontroller turns on the first transistor to turn on the second transistor to enter a self-holding state, and the voltage detector detects a ground through the diode and the first transistor within the delay time so that the voltage detector stops detecting the battery voltage.

### CROSS-REFERENCE TO RELATED APPLICATION

This application claims benefit of priority to Taiwanese Patent Application No. 113213192 filed Dec. 2, 2024, the entire contents of which are incorporated herein by reference.

### BACKGROUND OF THE DISCLOSURE

### Technical Field

The present disclosure relates to a power control apparatus, and especially relates to an electric tool power control apparatus.

### Description of Related Art

The power-saving method for the standby mode of the related art electric tool utilizes the standby mode of the microcontroller itself to minimize the energy consumption, while retaining only the necessary functions for the rapid restart. However, this method still requires the power conversion circuit to continuously supply power to the microcontroller. Therefore, the energy consumption of the standby mode of the related art electric tool remains high.

### SUMMARY OF THE INVENTION

In order to solve the above-mentioned problems, an object of the present disclosure is to provide an electric tool power control apparatus.

In order to achieve the object of the present disclosure mentioned above, the electric tool power control apparatus of the present disclosure is applied to a motor, a motor driver, and a battery pack. The motor is electrically connected to the motor driver. The electric tool power control apparatus includes: a microcontroller, electrically connected to the battery pack; a power converter, electrically connected to the microcontroller; a voltage detector, electrically connected to the power converter; a trigger switch, electrically connected to the microcontroller, the motor driver, and the battery pack; and a self-holding circuit, electrically connected to the microcontroller, the trigger switch, the voltage detector, the power converter, and the battery pack. Moreover, when the trigger switch is turned on, the voltage detector is configured to detect a battery voltage provided by the battery pack, and the voltage detector is configured to perform a delay time, and the power converter is configured to receive the battery voltage and convert the battery voltage into a driving voltage and transmit the driving voltage to the microcontroller to drive and wake up the microcontroller, and after the microcontroller is awakened, the microcontroller is configured to utilize the self-holding circuit to enter a self-holding state, and the voltage detector is configured to detect a ground through the self-holding circuit within the delay time so that the voltage detector is configured to stop detecting the battery voltage.

Moreover, in an embodiment of the electric tool power control apparatus of the present disclosure mentioned above, the self-holding circuit includes: a first transistor, electrically connected to the microcontroller; a second transistor, electrically connected to the first transistor, the trigger switch, the voltage detector, the power converter, the microcontroller, and the battery pack; a third transistor, electrically connected to the voltage detector and the power converter; and a first diode, electrically connected to the first transistor, the second transistor, and the voltage detector. Moreover, when the trigger switch is turned on, the voltage detector is configured to keep the third transistor turned off within the delay time, and after the microcontroller is awakened, the microcontroller is configured to turn on the first transistor to turn on the second transistor to enter the self-holding state, and the voltage detector is configured to detect the ground through the first diode and the first transistor within the delay time so that the voltage detector is configured to stop detecting the battery voltage.

Moreover, in an embodiment of the electric tool power control apparatus of the present disclosure mentioned above, when the microcontroller detects that the trigger switch has been locked on for more than a predetermined time period, or when the microcontroller detects that the battery voltage of the battery pack is less than a threshold voltage, the microcontroller is configured to turn off the first transistor to turn off the second transistor to end the self-holding state, and the voltage detector is configured to detect the battery voltage provided by the battery pack, and the voltage detector is configured to perform the delay time and upon reaching an end of the delay time, turn on the third transistor, so that the power converter is configured to stop receiving the battery voltage, stop converting the battery voltage into the driving voltage, and stop transmitting the driving voltage to the microcontroller, so that the microcontroller is configured to stop being driven, such that the electric tool power control apparatus is configured to enter a standby mode.

Moreover, in an embodiment of the electric tool power control apparatus of the present disclosure mentioned above, the electric tool power control apparatus further includes: a first capacitor, electrically connected to the motor driver, the trigger switch, the voltage detector, and the power converter; a first voltage detection circuit, electrically connected to the second transistor, the trigger switch, the microcontroller, and the battery pack; a second voltage detection circuit, electrically connected to the second transistor, the trigger switch, the first capacitor, the motor driver, the voltage detector, and the power converter; a comparator, electrically connected to the first voltage detection circuit and the second voltage detection circuit; and a second diode, electrically connected to the comparator, the first diode, and the voltage detector. Moreover, when the trigger switch is turned off, the first voltage detection circuit is configured to detect the battery voltage, and the second voltage detection circuit is configured to detect that the first capacitor starts to discharge, so that the first voltage detection circuit and the second voltage detection circuit are configured to drive the comparator to through the second diode cause the voltage detector to be configured to detect the ground through the second diode and the comparator, so that the voltage detector is configured to stop detecting the battery voltage, such that the voltage detector is configured to turn off the third transistor, so that the power converter is configured to be activated to drive the microcontroller.

Moreover, in an embodiment of the electric tool power control apparatus of the present disclosure mentioned above, the first voltage detection circuit includes: a first resistor, electrically connected to the second transistor, the trigger switch, the microcontroller, and the battery pack; and a second resistor, electrically connected to the first resistor and the comparator. Moreover, the second voltage detection circuit includes: a third resistor, electrically connected to the second transistor, the trigger switch, the first capacitor, the motor driver, the voltage detector, and the power converter; and a fourth resistor, electrically connected to the third resistor and the comparator.

Moreover, in an embodiment of the electric tool power control apparatus of the present disclosure mentioned above, the electric tool power control apparatus further includes: a fifth resistor, electrically connected to the second transistor and the first resistor; and a sixth resistor, electrically connected to the second transistor, the fifth resistor, the first transistor, and the first diode.

Moreover, in an embodiment of the electric tool power control apparatus of the present disclosure mentioned above, the electric tool power control apparatus further includes: a third diode, electrically connected to the second transistor, the third resistor, the voltage detector, the power converter, the trigger switch, the first capacitor, and the motor driver.

Moreover, in an embodiment of the electric tool power control apparatus of the present disclosure mentioned above, the electric tool power control apparatus further includes: a fourth diode, electrically connected to the trigger switch, the battery pack, the microcontroller, the second transistor, the fifth resistor, and the first resistor.

Moreover, in an embodiment of the electric tool power control apparatus of the present disclosure mentioned above, the battery voltage is 18 volts, the threshold voltage is 14 volts, and the driving voltage is 12 volts or 3.3 volts.

Moreover, in an embodiment of the electric tool power control apparatus of the present disclosure mentioned above, the delay time is 100 milliseconds or 200 milliseconds.

The advantage of the present disclosure is to reduce the energy consumption when the electric tool is in the standby mode.

Please refer to the detailed descriptions and figures of the present disclosure mentioned below for further understanding technologies, methods, and effects and achieving the predetermined purposes of the present disclosure. Further, the purposes, characteristics, and features of the present disclosure may be more deeply and specifically understood. However, the drawings are provided only for references and descriptions and not intended to limit the scope of the present disclosure.

### BRIEF DESCRIPTION OF THE DRAWINGS

FIG. 1 shows a circuit block diagram of an embodiment of the electric tool power control apparatus of the present disclosure.

FIG. 2 shows a waveform diagram of a power-saving embodiment of the electric tool power control apparatus of the present disclosure.

FIG. 3 shows a voltage waveform diagram of an embodiment of the electric tool power control apparatus of the present disclosure.

FIG. 4 shows a circuit block diagram of another embodiment of the electric tool power control apparatus of the present disclosure.

FIG. 5 shows a comparison chart of the pressing stroke of the trigger switch of the present disclosure.

### DETAILED DESCRIPTION

In the present disclosure, numerous specific details are provided, to provide a comprehensive understanding of embodiments of the present disclosure. However, those skilled in the art may understand that the present disclosure may be practiced without one or more of these specific details. In other instances, well-known details are not shown or described to avoid obscuring features of the present disclosure. The technical content and the detailed description of the present disclosure are as follows with reference to the figures.

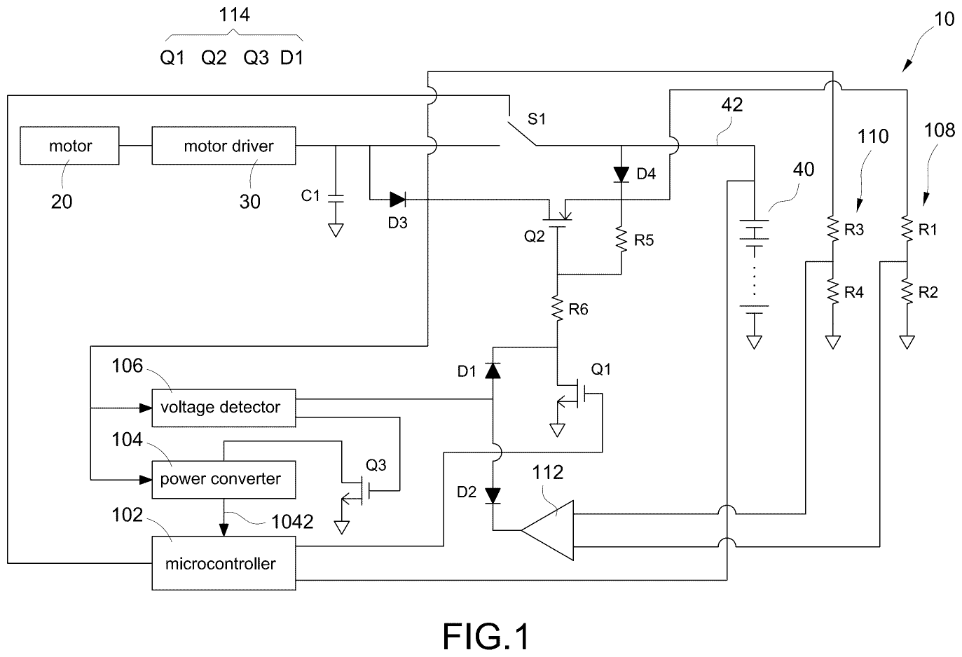

FIG. 1 shows a circuit block diagram of an embodiment of the electric tool power control apparatus 10 of the present disclosure. The electric tool power control apparatus 10 of the present disclosure is applied to a motor 20, a motor driver 30, and a battery pack 40. The electric tool power control apparatus 10 includes a microcontroller 102, a power converter 104, a voltage detector 106, a first voltage detection circuit 108, a second voltage detection circuit 110, a comparator 112, a self-holding circuit 114, a first capacitor C1, a second diode D2, a third diode D3, a fourth diode D4, a fifth resistor R5, a sixth resistor R6, and a trigger switch S1. The self-holding circuit 114 includes a first diode D1, a first transistor Q1, a second transistor Q2, and a third transistor Q3. The first voltage detection circuit 108 includes a first resistor R1 and a second resistor R2. The second voltage detection circuit 110 includes a third resistor R3 and a fourth resistor R4. The components mentioned above are electrically connected to each other.

The power converter 104, which has an enabling function, is, for example, a buck integrated circuit with the model number RT6200. The voltage detector 106, which has a time delay function, is, for example, a voltage detector integrated circuit with the model number APX809S.

When the trigger switch S1 is turned on, the voltage detector 106 is configured to detect a battery voltage 42 (for example, 18 volts) provided by the battery pack 40 through the third diode D3 and the trigger switch S1, and the voltage detector 106 is configured to perform a delay time (for example, 100 milliseconds or 200 milliseconds) and keep the third transistor Q3 turned off within the delay time, and the power converter 104 is configured to receive the battery voltage 42 through the third diode D3 and the trigger switch S1, convert the battery voltage 42 into a driving voltage 1042 (for example, 12 volts or 3.3 volts), and transmit the driving voltage 1042 to the microcontroller 102 to drive and wake up the microcontroller 102, and after the microcontroller 102 is driven and awakened, the microcontroller 102 is configured to utilize the self-holding circuit 114 (i.e., turning on the first transistor Q1 to turn on the second transistor Q2) to enter a self-holding state, and the voltage detector 106 is configured to detect the ground through the self-holding circuit 114 (i.e., the first diode D1 and the first transistor Q1 which is turned on) within the delay time, so that the voltage detector 106 is configured to stop detecting the battery voltage 42 (i.e., disabling the voltage detection function of the voltage detector 106). The present disclosure has the function of the system delayed shutdown.

When the microcontroller 102 detects that the trigger switch S1 has been locked on for more than a predetermined time period (for example, four hours), or when the microcontroller 102 detects that the battery voltage 42 of the battery pack 40 is less than a threshold voltage (for example, 14 volts), the microcontroller 102 is configured to turn off the first transistor Q1 to turn off the second transistor Q2 to end the self-holding state, and since the voltage detector 106 may not detect the ground through the first diode D1 and the first transistor Q1, the voltage detector 106 is configured to start to detect the battery voltage 42 provided by the battery pack 40 (i.e., enabling the voltage detection function of the voltage detector 106), and the voltage detector 106 is configured to perform the delay time and upon reaching an end of the delay time, turn on the third transistor Q3, so that the power converter 104 is configured to detect the ground to be configured to stop receiving the battery voltage 42, stop converting the battery voltage 42 into the driving voltage 1042, and stop transmitting the driving voltage 1042 to the microcontroller 102, so that the microcontroller 102 is configured to stop being driven, such that the electric tool power control apparatus 10 is configured to enter a standby mode.

When the trigger switch S1 is turned off, the first voltage detection circuit 108 is configured to detect the battery voltage 42 through the fourth diode D4, and the second voltage detection circuit 110 is configured to through the third diode D3 detect that the first capacitor C1 starts to discharge, so that the first voltage detection circuit 108 and the second voltage detection circuit 110 are configured to drive the comparator 112 to through the second diode D2 cause the voltage detector 106 to be configured to detect the ground through the second diode D2 and the comparator 112, so that the voltage detector 106 is configured to stop detecting the battery voltage 42 (i.e., disabling the voltage detection function of the voltage detector 106), such that the voltage detector 106 is configured to turn off the third transistor Q3, so that the power converter 104 is configured to be activated to drive and wake up the microcontroller 102.

Next, as described above, after the microcontroller 102 is driven and awakened, the microcontroller 102 is configured to turn on the first transistor Q1 to turn on the second transistor Q2 to enter the self-holding state, and the voltage detector 106 is configured to detect the ground through the first diode D1 and the first transistor Q1 (which is turned on) within the delay time, so that the voltage detector 106 is configured to stop detecting the battery voltage 42 (i.e., disabling the voltage detection function of the voltage detector 106). At this point, the electric tool power control apparatus 10 of the present disclosure returns to a normal startup state. If the trigger switch S1 is pressed again, the electric tool may start quickly.

Moreover, the first voltage detection circuit 108 and the second voltage detection circuit 110 may be set to different voltage levels to determine a speed at which the voltage detector 106 is released (i.e., turned off). When a voltage transmitted from the first voltage detection circuit 108 to the comparator 112 and a voltage transmitted from the second voltage detection circuit 110 to the comparator 112 are different, an output terminal of the comparator 112 is regarded as the ground. Because the present disclosure utilizes the voltage difference setting between the first voltage detection circuit 108 and the second voltage detection circuit 110, once the trigger switch S1 is opened (i.e., turned off), the standby mode may be quickly released (without waiting for the first capacitor C1 to self-discharge to a threshold voltage of the voltage detector 106) to re-supply power to the microcontroller 102. This prevents the electric tool from failing to start when the trigger switch S1 is pressed again.

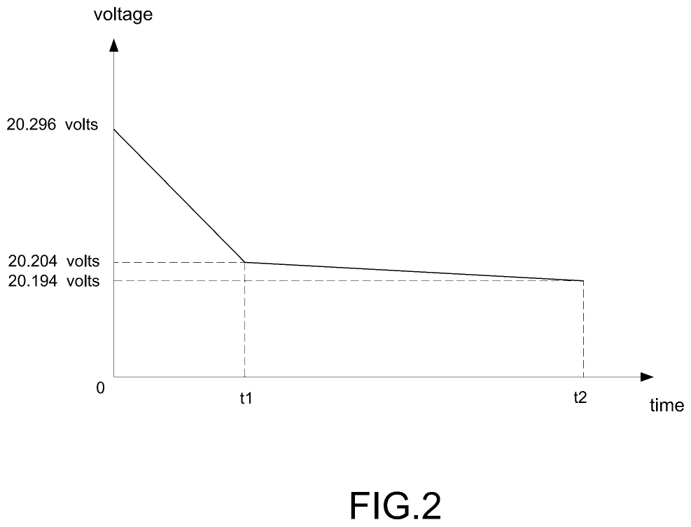

FIG. 2 shows a waveform diagram of a power-saving embodiment of the electric tool power control apparatus 10 of the present disclosure. It should be noted that FIG. 2 is not drawn to scale. Please refer to FIG. 1 at the same time. When the microcontroller 102 detects that the trigger switch S1 has been locked on for a first time point t1 (the fourth hour) (for example, the user locks the trigger switch S1 but forgets to release the trigger switch S1), the microcontroller 102 detects this abnormal condition and starts to enter the standby mode to save power (i.e., entering the standby mode after the first time point t1 (the fourth hour)). During the four hours before entering the standby mode, the battery voltage 42 dropped by 0.092 volts (20.296 volts−20.204 volts=0.092 volts). However, after entering the standby mode, over a period of fifteen hours (i.e., a second time point t2 at the nineteenth hour), the battery voltage 42 dropped by only 0.01 volts (20.204 volts−20.194 volts=0.01 volts), greatly reducing the energy consumption.

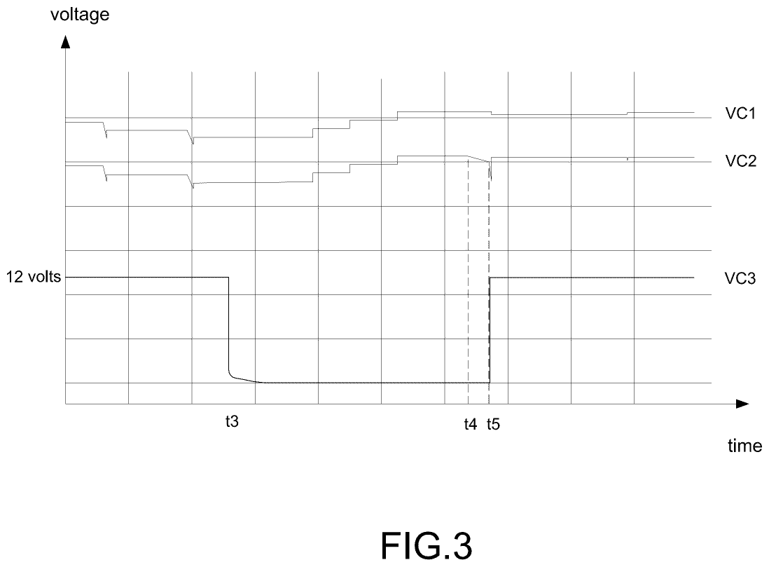

FIG. 3 shows a voltage waveform diagram of an embodiment of the electric tool power control apparatus 10 of the present disclosure. It should be noted that FIG. 3 is not drawn to scale (especially, a first voltage curve VC1 and a second voltage curve VC2 are actually very close). Please refer to FIG. 1 at the same time. FIG. 3 is intended to illustrate the locked-on state of the trigger switch S1 and show a voltage variation test conducted to verify the fast standby release function of the present disclosure. In FIG. 3, the first voltage curve VC1 represents the voltage of the first voltage detection circuit 108, the second voltage curve VC2 represents the voltage of the second voltage detection circuit 110, and a third voltage curve VC3 represents the driving voltage 1042 of the power converter 104.

For the third voltage curve VC3, before a third time point t3, the voltage supplied to the microcontroller 102 is 12 volts. At the third time point t3, the voltage rapidly drops below the threshold value to enter the standby mode. Next, for the second voltage curve VC2, at a fourth time point t4, the trigger switch S1 is released (i.e., turned off), and the first capacitor C1 starts to discharge. Then, approximately 0.3 seconds later, at a fifth time point t5, for the third voltage curve VC3, the voltage supplied to the microcontroller 102 rapidly rises, and the power to the microcontroller 102 is re-established.

Please refer to FIG. 1 again. The present disclosure detects the voltage across the two terminals of the trigger switch S1 to control the power-saving mode of the tool. The present disclosure uses the trigger switch S1 (a mechanical trigger switch) as a component for establishing the power of the tool, and the trigger switch S1 includes a mechanical lock-on structure. In the related art, when the user does not release the lock-on state of the trigger switch S1, the microcontroller 102 continuously consumes the battery energy, leading to the excessive battery discharge and eventually causing the battery damage. However, the present disclosure utilizes the voltage detector 106, which is close to the system side and electrically connected to power terminals of the trigger switch S1, to completely shut down the system power and enter the standby mode, thereby greatly reducing the energy loss. The present disclosure utilizes the voltage detector 106 electrically connected between two power terminals of the trigger switch S1 to achieve a fast release of the system power-off state.

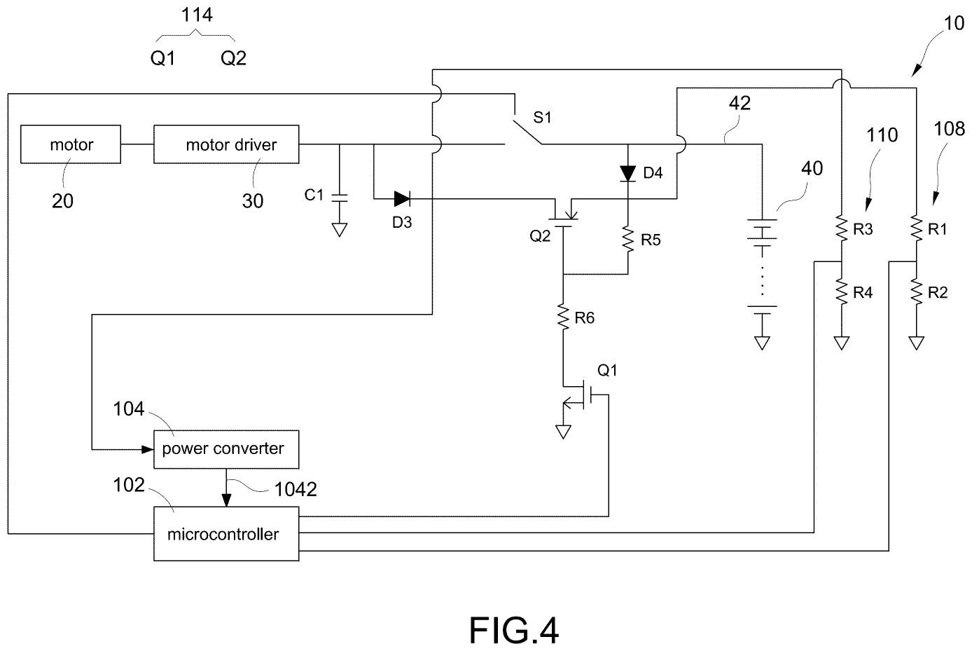

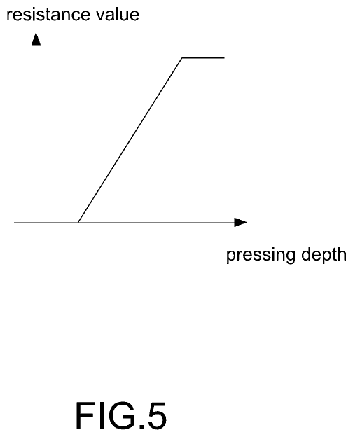

FIG. 5 shows a comparison chart of the pressing stroke of the trigger switch S1 of the present disclosure. As shown in FIG. 5, the deeper the trigger switch S1 is pressed, the greater the resistance value; however, after reaching a certain depth, the resistance value remains constant. FIG. 4 shows a circuit block diagram of another embodiment of the electric tool power control apparatus 10 of the present disclosure. The descriptions of the elements shown in FIG. 4 which are the same as the elements shown in FIG. 1 are not repeated here for brevity. Please refer to FIG. 5 at the same time.

If the trigger switch S1 does not have a lock-on structure, when the trigger switch S1 is released (i.e., turned off; at this time, the stroke of the trigger switch S1 returns to the original position), the microcontroller 102 may detect and determine that the trigger switch S1 has been released and starts timing. Upon reaching a time threshold value, the microcontroller 102 turns off the first transistor Q1 to end the self-holding function, and then the system powers down. However, after the first transistor Q1 is turned off, if the microcontroller 102 may still know that the first voltage detection circuit 108 and the second voltage detection circuit 110 may still detect that a voltage exists across the two terminals of the trigger switch S1, the microcontroller 102 may determine that an abnormal short circuit has occurred at the power terminals of the trigger switch S1 (for example, abnormal sticking, which may cause the battery pack 40 to continue discharging and potentially damage the battery pack 40). At this time, the present disclosure may use related electronic components (not shown in FIG. 4, for example, a buzzer, a light-emitting diode, or a vibrator) to generate sound, light, or vibration to notify the user of this abnormal condition.

The advantage of the present disclosure is to reduce the energy consumption when the electric tool is in the standby mode.

Although the present disclosure has been described with reference to the embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure.

What is claimed is:

1. An electric tool power control apparatus, applied to a motor, a motor driver, and a battery pack, the motor being electrically connected to the motor driver, the electric tool power control apparatus comprising:
a microcontroller, electrically connected to the battery pack;
a power converter, electrically connected to the microcontroller;
a voltage detector, electrically connected to the power converter;
a trigger switch, electrically connected to the microcontroller, the motor driver, and the battery pack; and
a self-holding circuit, electrically connected to the microcontroller, the trigger switch, the voltage detector, the power converter, and the battery pack,
wherein when the trigger switch is turned on, the voltage detector is configured to detect a battery voltage provided by the battery pack, and the voltage detector is configured to perform a delay time, and the power converter is configured to receive the battery voltage and convert the battery voltage into a driving voltage and transmit the driving voltage to the microcontroller to drive and wake up the microcontroller, and after the microcontroller is awakened, the microcontroller is configured to utilize the self-holding circuit to enter a self-holding state, and the voltage detector is configured to detect a ground through the self-holding circuit within the delay time so that the voltage detector is configured to stop detecting the battery voltage.

2. The electric tool power control apparatus according to claim 1, wherein the self-holding circuit comprises:
a first transistor, electrically connected to the microcontroller;
a second transistor, electrically connected to the first transistor, the trigger switch, the voltage detector, the power converter, the microcontroller, and the battery pack;
a third transistor, electrically connected to the voltage detector and the power converter; and
a first diode, electrically connected to the first transistor, the second transistor, and the voltage detector,
wherein when the trigger switch is turned on, the voltage detector is configured to keep the third transistor turned off within the delay time, and after the microcontroller is awakened, the microcontroller is configured to turn on the first transistor to turn on the second transistor to enter the self-holding state, and the voltage detector is configured to detect the ground through the first diode and the first transistor within the delay time so that the voltage detector is configured to stop detecting the battery voltage.

3. The electric tool power control apparatus according to claim 2, wherein when the microcontroller detects that the trigger switch has been locked on for more than a predetermined time period, or when the microcontroller detects that the battery voltage of the battery pack is less than a threshold voltage, the microcontroller is configured to turn off the first transistor to turn off the second transistor to end the self-holding state, and the voltage detector is configured to detect the battery voltage provided by the battery pack, and the voltage detector is configured to perform the delay time and upon reaching an end of the delay time, turn on the third transistor, so that the power converter is configured to stop receiving the battery voltage, stop converting the battery voltage into the driving voltage, and stop transmitting the driving voltage to the microcontroller, so that the microcontroller is configured to stop being driven, such that the electric tool power control apparatus is configured to enter a standby mode.

4. The electric tool power control apparatus according to claim 3, further comprising:
a first capacitor, electrically connected to the motor driver, the trigger switch, the voltage detector, and the power converter;
a first voltage detection circuit, electrically connected to the second transistor, the trigger switch, the microcontroller, and the battery pack;
a second voltage detection circuit, electrically connected to the second transistor, the trigger switch, the first capacitor, the motor driver, the voltage detector, and the power converter;
a comparator, electrically connected to the first voltage detection circuit and the second voltage detection circuit; and
a second diode, electrically connected to the comparator, the first diode, and the voltage detector,
wherein when the trigger switch is turned off, the first voltage detection circuit is configured to detect the battery voltage, and the second voltage detection circuit is configured to detect that the first capacitor starts to discharge, so that the first voltage detection circuit and the second voltage detection circuit are configured to drive the comparator to through the second diode cause the voltage detector to be configured to detect the ground through the second diode and the comparator, so that the voltage detector is configured to stop detecting the battery voltage, such that the voltage detector is configured to turn off the third transistor, so that the power converter is configured to be activated to drive the microcontroller.

5. The electric tool power control apparatus according to claim 4, wherein the first voltage detection circuit comprises:
a first resistor, electrically connected to the second transistor, the trigger switch, the microcontroller, and the battery pack; and
a second resistor, electrically connected to the first resistor and the comparator,
wherein the second voltage detection circuit comprises:
a third resistor, electrically connected to the second transistor, the trigger switch, the first capacitor, the motor driver, the voltage detector, and the power converter; and
a fourth resistor, electrically connected to the third resistor and the comparator.

6. The electric tool power control apparatus according to claim 5, further comprising:
a fifth resistor, electrically connected to the second transistor and the first resistor; and
a sixth resistor, electrically connected to the second transistor, the fifth resistor, the first transistor, and the first diode.

7. The electric tool power control apparatus according to claim 6, further comprising:
a third diode, electrically connected to the second transistor, the third resistor, the voltage detector, the power converter, the trigger switch, the first capacitor, and the motor driver.

8. The electric tool power control apparatus according to claim 7, further comprising:
a fourth diode, electrically connected to the trigger switch, the battery pack, the microcontroller, the second transistor, the fifth resistor, and the first resistor.

9. The electric tool power control apparatus according to claim 8, wherein the battery voltage is 18 volts, the threshold voltage is 14 volts, and the driving voltage is 12 volts or 3.3 volts.

10. The electric tool power control apparatus according to claim 9, wherein the delay time is 100 milliseconds or 200 milliseconds.
